(19) United States
(12) Patent Application Publication
(10) Pub. No.: US 2025/0349957 A1
(43) Pub. Date: Nov. 13, 2025

(54) BATTERY ASSEMBLE AND ASSEMBLING METHOD OF THE SAME

(71) Applicant: SK ON CO., LTD., Seoul (KR)

(72) Inventors: Won Gab HWANG, Daejeon (KR); Chae Won NA, Daejeon (KR); Gang U LEE, Daejeon (KR); Kyu Hyun HAN, Daejeon (KR)

(21) Appl. No.: 19/201,922

(22) Filed: May 8, 2025

(30) Foreign Application Priority Data
May 8, 2024 (KR) 10-2024-0060658

(51) Int. Cl. H01M 50/24; A62C 3/16; A62C 99/00; H01M 50/211; H01M 50/222; H01M 50/271

(52) U.S. Cl. CPC H01M 50/24; A62C 3/16; A62C 99/0018; H01M 50/211; H01M 50/222; H01M 50/271

(57) ABSTRACT

The present disclosure relates to a battery assembly comprising: a plurality of battery cells stacked and arranged in a predetermined stacking direction; an accommodation case housing the plurality of battery cells; an insertion space formed between the plurality of battery cells and the accommodation case along the stacking direction; and a thermal delay assembly located in the insertion space, the thermal delay assembly including: a fire-extinguishing member; and a columnar housing member housing the fire-extinguishing members therein and extending along a height direction of the accommodation case; and an assembly method thereof.

### CROSS-REFERENCE TO RELATED PATENT APPLICATION

The present application claims priority under 35 U.S.C. § 119 (a) to Korean patent application number 10-2024-0060658 filed on May 8, 2024, in the Korean Intellectual Property Office, the entire disclosure of which is incorporated by reference herein.

### BACKGROUND OF THE INVENTION

### 1. Field

Embodiments of the present disclosure relate to a battery assembly and an assembly method thereof. More specifically, the present invention relates to a battery assembly having improved thermal stability and an assembly method thereof.

### 2. Description of the Related Art

Recently, due to a fire or explosion accident that occurred when using a lithium secondary battery, social concerns about the safety of battery use are increasing. Based on these social concerns, one of the major development tasks of lithium secondary batteries in recent years is to eliminate the unsafety such as fire and explosion caused by thermal runaway of battery cells.

In particular, battery modules/packs have empty spaces other than battery cells, which are energy sources. If a fire occurs due to an external impact or a problem with a battery cell, the flame may spread to an adjacent cell through an empty space, and the damage caused by the fire may increase. The risk of such fires can be the biggest obstacle to the electric vehicle market, so the design of ways to lower the spread of fires continues to be studied.

### SUMMARY OF THE INVENTION

According to one aspect of the present disclosure, an object is to prevent or mitigate the escape of high-temperature gas generated in one or more battery cells in the battery assembly that have experienced thermal runaway from the battery cells toward the taps of the battery cells.

Another aspect of the present disclosure, an object is to provide to vent according to the intended path the high-temperature gas generated in the battery cell in which the thermal runaway occurs.

Another aspect of the present disclosure, an object is to provide to the stability of the battery assembly can be improved by increasing heat resistance or fire resistance.

Another aspect of the present disclosure, an object is to provide to the assembly process further comprising inserting a thermal retarder assembly (which may be referred to as any of a filler, capsule member, and insertion member) into the void formed between the busbar assembly and the cell tabs of the battery.

Another aspect of the present disclosure, an object is to provide to an assembly method that facilitates placement of a thermal delay assembly when assembling a battery assembly.

The present disclosure may be widely applied in green technology fields using batteries such as electric vehicles. In addition, the battery cell of the present disclosure may be used in eco-friendly electric vehicles, hybrid vehicles, etc. to prevent climate change by suppressing air pollution and greenhouse gas emissions.

As a technical means to achieve the technical objects, a battery assembly according to the present disclosure comprises: a plurality of battery cells stacked and arranged in a stacking direction; an accommodation case accommodating the plurality of battery cells; an insertion space formed between the plurality of battery cells and the accommodation case along the stacking direction; and a thermal delay assembly located in the insertion space, and the thermal delay assembly may include: a fire-extinguishing member; and a columnar housing member housing the fire-extinguishing member therein and extending along a height direction of the housing case.

According to an embodiment, the fire-extinguishing member may start to generate a fire-extinguishing gas at a predetermined first temperature.

According to an embodiment, the housing member may begin to melt at a predetermined second temperature.

According to an embodiment, the first temperature may be higher than or equal to the second temperature.

According to an embodiment, the fire-extinguishing member may comprise one or more of a potassium compound, a phosphoric acid compound, or any combination thereof, which are pyrolyzed at the first temperature to generate the fire-extinguishing gas.

According to an embodiment, the housing member may further comprise a fire-resistant member having a plurality of bead shapes including a fire-resistant material therein.

According to an embodiment, the fire-extinguishing member may have a plurality of bead shapes.

According to an embodiment, each of the fire-resistant member and the fire-extinguishing member may be provided in a plurality and mixed with each other to be accommodated in the housing member.

According to an embodiment, the fire-resistant material may include silicon dioxide (SiO₂).

According to an embodiment, the fire-extinguishing member may be a liquid.

According to an embodiment, one end of at least one of both ends of the housing member may be tapered.

According to an embodiment, the housing member may comprise: a body portion having a pipe shape and extending along a height direction of the accommodation case; a first end portion coupled to an upper side of the body portion and closing one of both open ends of the body portion; and a second end portion coupled to a lower side of the body portions and closing the other open end, wherein the first end portion may have a tapered shape in the direction away from the body portion.

According to an embodiment, the second end portion may comprise an end face arranged in parallel with the bottom surface of the accommodation case.

According to an embodiment, the accommodation case may comprise: a receiving body that includes an open upper surface and receives the plurality of battery cells through the open upper surface; and a receiving cover that is coupled to the receiving body and covers the open upper surface, and one end of both ends of the housing member that is closer to the receiving cover than the receiving body may be tapered.

According to an embodiment, a length of the housing member along a height direction of the accommodation case may be longer than a length of the housing member along the stacking direction of the accommodation case.

According to an embodiment, a maximum length of the thermal delay assembly along the stacking direction may be less than or equal to the thickness of any one of the plurality of battery cells.

According to an embodiment, the battery assembly according to the present disclosure may further include a heat blocking member positioned in at least a portion between the plurality of battery cells.

According to an embodiment, the battery assembly according to the present disclosure may further include a busbar electrically connected to the plurality of battery cells, and the insertion space may be located between the busbar and the plurality of battery cells.

According to an embodiment, the insertion space is located outside the plurality of battery cells and is separated into a plurality of separation spaces formed by tab portions of the adjacent battery cells and the busbar, and the thermal delay assembly is provided in a plurality of pieces and may be inserted into at least a part of the plurality of separation spaces.

According to an embodiment, the housing member may extend along the height direction of the accommodation case.

As a technical means to achieve the technical objects, an assembling method for a battery assembly, the assembling method comprising: stacking a plurality of battery cells in a stacking direction; an accommodation case for accommodating the plurality of battery cells; an insertion space formed between the plurality of battery cells and the accommodation case along the stacking direction; and a thermal delay assembly located in the insertion space; wherein the method of assembling the battery assembly according to the present disclosure comprises: stacking the plurality of battery cells; coupling the stacked plurality of battery cells to a receiving cover; inserting the thermal delay assembly into the insertion space, the thermal delay assembly comprising a fire-resistant member having a plurality of bead shapes and including of a fire-resistant material, a fire-resistant member having a plurality of bead shapes and starting to generate a fire-extinguishing gas at a predetermined first temperature, and a housing member that accommodates the fire-resistant member and the fire-extinguishing member therein and extends along a height direction of the accommodation case; and coupling a receiving body that is coupled to the receiving cover to form the accommodation case to the housing cover.

According to an embodiment, the assembling method further comprising: prior to the step of inserting the thermal delay assembly into the insertion space, a first positioning step of positioning the plurality of stacked battery cells after being coupled to the receiving cover.

According to an embodiment, in the step of coupling the receiving body to the receiving cover, after the first positioning step, the plurality of stacked battery cells and the receiving cover may be coupled with the receiving body.

According to an embodiment, the assembling method further comprising: a second positioning step of positioning the accommodation case after the step of coupling the housing body to the housing cover.

### BRIEF DESCRIPTION OF THE DRAWINGS

FIG. 1 is an embodiment of a battery assembly according to the present disclosure.

FIG. 2 is an embodiment of disassembling a battery assembly according to the present disclosure.

FIG. 3 is a top view of a battery assembly according to the present disclosure.

FIG. 4 is an enlargement of part S1 of FIG. 3.

FIG. 5 schematically illustrates an embodiment of a thermal delay assembly accommodated in the insertion space as seen above.

FIG. 6A illustrates an embodiment of a thermal delay assembly received in an insertion space. FIG. 6B shows one side of the thermal delay assembly shown in FIG. 6A. FIG. 6C is a breakdown of an embodiment of a housing member.

FIG. 7A illustrates another embodiment of a thermal delay assembly received in an insertion space. FIG. 7B illustrates another embodiment of a thermal delay assembly received in an insertion space.

FIG. 8 is a top view of an embodiment of a battery assembly according to the present disclosure from above.

FIG. 9 illustrates one aspect of an embodiment of a battery assembly according to the present disclosure.

FIG. 10 shows a schematic form in which the housing member is melted and the fire-resistant member and/or the fire-extinguishing member are stacked as grains in the insertion space.

FIG. 11 illustrates an embodiment in which the fire-resistant member and/or the fire-extinguishing member moves in the insertion space due to flame or high-temperature gas.

FIG. 12 is a flowchart illustrating an embodiment of a manufacturing process of a battery assembly according to the present disclosure.

FIG. 13 illustrates another embodiment of a battery assembly according to the present disclosure.

### DETAILED DESCRIPTION

Hereinafter, preferred embodiments of the present disclosure will be described in detail with reference to the accompanying drawings. The configuration and control methods of the devices described below are merely for describing the embodiments of the present disclosure and not for limiting the scope of the present disclosure, and like reference numerals used throughout the specification refer to like elements.

In addition, the battery assemblies 200 and 300 according to the present disclosure are collectively referred to as battery modules or battery packs. Accordingly, battery assemblies 200 and 300 according to the present disclosure may refer to battery modules as well as battery packs that receive battery cells without a battery assembly, such as Cell to Pack (CTP).

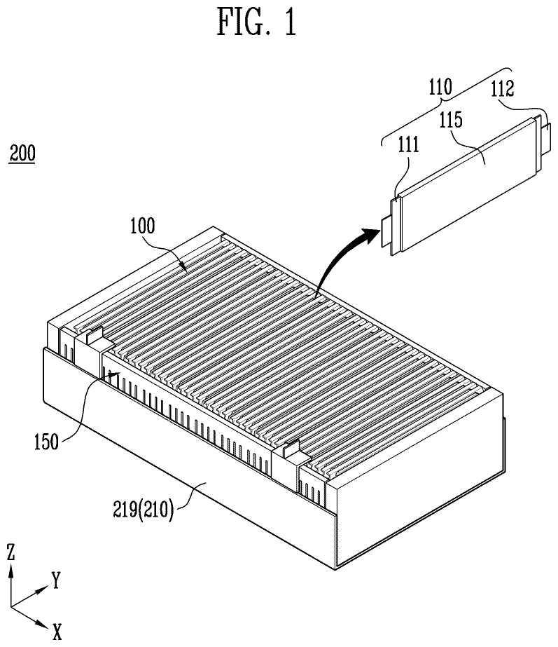

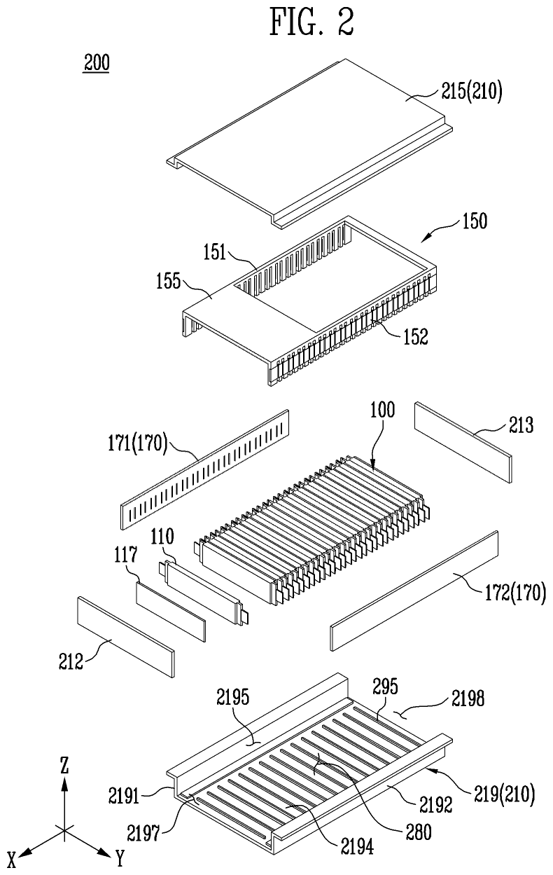

FIG. 1 is an embodiment of a battery assembly 200 according to the present disclosure.

Referring to FIG. 1, the battery assembly 200 includes a plurality of battery cells 110 and an accommodation case 210 for accommodating the battery cells 110.

Meanwhile, each of the plurality of battery cells 110 may include a main body 115 that generates or stores electric energy, and lead tab portions 111 and 112 protruding from the main body 115 to the outside of the main body 115. The main body 115 may include an electrode assembly (not shown) including a positive electrode and a negative electrode therein for the production and storage of electrical energy therein.

The main body 115 further includes an electrolyte (not shown) in contact with the electrode assembly. The electrolyte may be liquid or solid. In addition, when the electrolyte is a liquid, the electrode assembly may further include a separation membrane for separating the positive electrode and the negative electrode. Referring to FIG. 1, the main body 115 may be in the form of a pouch sealed with a film-shaped exterior material.

FIG. 1 illustrates an embodiment of a battery cell 110 in the form of a pouch, but is not limited thereto. Therefore, it is also applicable to rectangular and cylindrical battery cells.

Specifically, the lead tab portions 111 and 112 may include a first lead tab portion 111 and a second lead tab portion 112 protruding from both sides of the main body 115 in a direction away from the main body 115. As an embodiment, the lead tab portions 111 and 112 may be provided with both tabs on one side.

Meanwhile, the accommodation case 210 is configured to protect the plurality of battery cells 110 from an external shock such as vibration. The accommodation case 210 may include a receiving body 219 that forms part of a receiving space 280 for receiving the plurality of battery cells 110, which will be described later.

In addition, the battery assembly 200 may further include a busbar assembly 150 (or a busbar assembly) that electrically connects the plurality of battery cells 110 to the outside. The busbar assembly 150 may include a busbar 170 (see FIG. 2) that electrically connects the plurality of battery cells 110 to output a predetermined voltage. A form in which the busbar assembly 150 or the busbar 170 to be described later is assembled with the plurality of battery cells 110 may be referred to as a cell stack 100.

FIG. 2 is an embodiment of disassembling a battery assembly 200 according to the present disclosure.

Referring to FIG. 2, the accommodation case 210 may include a receiving body 219 that forms a part of a receiving space 280 that receives the plurality of battery cells 110, and a receiving cover 215 that is coupled to the receiving body 219 to form the receiving space 280 together.

Inside the receiving body 219, the plurality of battery cells 110 may be overlapped in a predetermined stacking direction (e.g., X direction).

More specifically, the accommodation case 210 includes an open upper surface 2195, and may further include a receiving body 219 that receives the plurality of battery cells 110 through the open upper surface 2195, and a receiving cover 215 that is coupled to the receiving body 219 and closes the opened upper surface 2195.

Accordingly, the receiving cover 215 may be coupled to the receiving body 219 to form an upper surface of the receiving space 280 or an upper surface of the accommodation case 210. That is, the receiving cover 211 may be coupled to the receiving body 219 to close the opened upper surface 2195 and form the receiving space 280 together with the receiving body 229.

The receiving space 280 may be formed inside the receiving body 219 to accommodate the cell stack 100. The receiving space 280 may further include an insertion space 288, which will be described later.

Meanwhile, the receiving body 219 may have a channel shape or a U-shape with an opened upper surface. Referring to FIG. 2, of the side surfaces of the receiving body 219, both side surfaces 2197 and 2198 facing each other in the X direction may also be opened.

That is, the receiving body 219 may include a body bottom surface 2194 that forms a bottom surface of the receiving space 280, and body side surfaces 2191 and 2192 that extend toward the receiving cover 211 at corners (not shown) of the body bottom surface 2184 that are provided side by side along the stacking direction. The free ends of the body sides 2191, 2192 may be bent to form flanges (not shown). This is for easy coupling with the receiving cover 211.

Referring to FIGS. 1 and 2, the height of the receiving body 219 may be smaller than the heights of the plurality of battery cells 110. However, this is only an embodiment, and the height of the receiving body 219 may be greater than or equal to the heights of the plurality of battery cells 110.

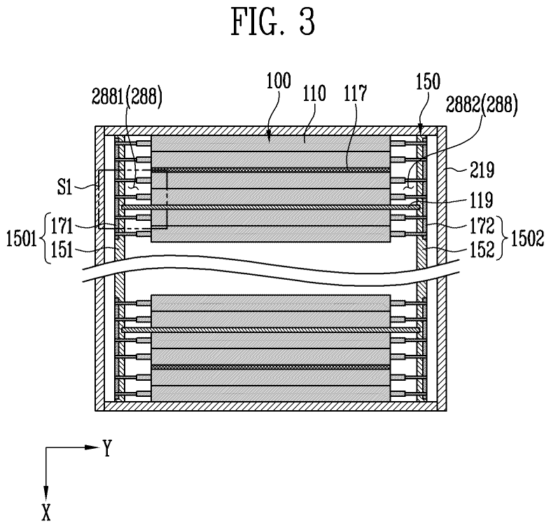

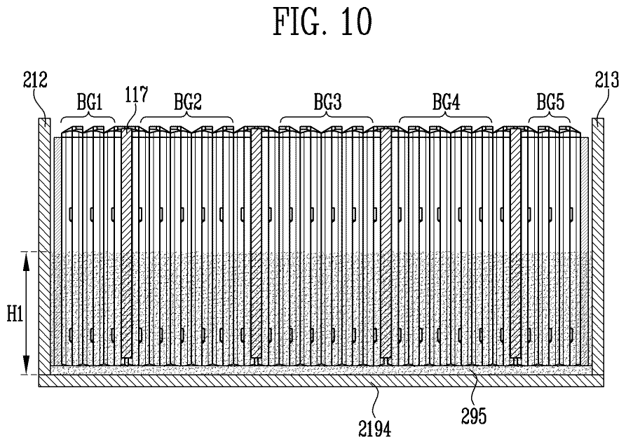

Meanwhile, the cell stack 100 may further include a buffer member 117 or a heat blocking member 119 (see FIG. 3) positioned between the plurality of battery cells 110. The buffer member 117 may be located between each of the battery cells 110, or may be located between battery groups BG1 to BG5 (see FIG. 10) in which the plurality of battery cells 110 are grouped. The same applies to the heat blocking member 119.

The heat blocking member 119 may serve as a thermal barrier to prevent flames or heat from spreading to other adjacent battery cells 110 when one battery cell 110 is thermally runaway.

The cell stack 100 may include at least one of the buffer members 117. Similarly, the cell stack 100 may include at least one of the heat blocking members 119. The buffer member 117 and the heat blocking member 119 may be formed as a single member to simultaneously perform a heat blocking function and a shock absorbing function.

To this end, the heat blocking member 119 may also be formed in a multilayer structure along a stacked direction of the plurality of battery cells 110. That is, one layer of the multilayer structure may be formed of a flame retardant material (or a fire-resistant material). Another layer of the multilayer structure may also serve to reduce the pressure on the other battery cells 110 when the battery cells 110 are swollen.

The plurality of battery cells 110 and the plurality of buffer members 117 may be provided at predetermined positions and stacked. For example, referring to FIG. 2, an embodiment in which long edges of the plurality of battery cells 110 are provided side by side in the Y direction is shown. Therefore, the plurality of battery cells 110 and the plurality of buffer members 117 will be positioned to overlap in the X direction. The same applies to the heat blocking member 119.

The heat blocking member 119 may be formed of a fire-resistant (heat-resistant or flame-retardant) material. For example, the heat blocking member 119 may be made of a material such as a refractory polymer or mica.

Meanwhile, referring to FIG. 2, the battery assembly 200 may further include end plates 212 and 213 at both ends of the cell stack 100 along the stacking direction. The end plates 212 and 213 may be provided on both ends of the cell stack 100, or may be formed to be connected to both side surfaces 2197 and 2198 of the receiving body 219.

The end plates 212 and 213 are configured to prevent both sides of the cell stack 100 from being exposed to the outside.

Meanwhile, the battery assembly 200 may include a busbar 170 electrically connected to the plurality of battery cells 110. In addition, the battery assembly 200 may further include busbar frames 151, 152, and 155 that support the busbar 170 and the plurality of battery cells 110. The busbar 170 and the busbar frames 151, 152, and 155 may be collectively referred to as a busbar assembly 150. That is, the busbar assembly 150 may include a busbar 170 electrically connected to the plurality of battery cells 110.

The busbar frames 151, 152, and 155 may be electrically connected to the outside to store (or charge) electrical energy in the plurality of battery cells 110 or to supply (or discharge) electrical energy stored in the plurality of the battery cells 110 to the outside.

The busbar assembly 150 may include a first busbar frame 151 and a second busbar frame 152 extending along a stacking direction of the plurality of battery cells 110 with the plurality of battery cells 110 interposed therebetween.

The busbar assembly 150 may further include a support frame 155 located on one side of the busbar assembly 150 and connecting the first busbar frame 151 and the second busbar frame 152.

The busbar assembly 150 is described using the case where the lead tab portions 111 and 112 are respectively located in opposite directions of the main body 115. Alternatively, when the lead tab portions 111, 112 are located on one side of the main body 115 and are located in the same direction, the busbar frames 151, 152 may be located on one side, e.g., on top of the main body 115, and electrically connected to the lead tab portions 111, 112.

The support frame 155 may serve to prevent and support deformation of the first busbar frame 151 and the second busbar frame 152. In addition, a part of the electrical device for sensing and controlling the plurality of battery cells 110 may be disposed on the support frame 155.

Referring to FIG. 2, the busbar assembly 150 may have a tunnel shape. The length of the first busbar frame 151 and the length of the second busbar frame 152 along the stacking direction may be longer than the length of the support frame 155.

That is, the support frame 155 may be connected to the first busbar frame 151 and the second busbar frame 152 to cover upper portions of the plurality of battery cells 110. That is, the support frame 155 may cover not only a part of the upper portions of the plurality of battery cells 110 but also all of them.

Referring to FIG. 2, the busbar 170 may include a first busbar 171 supported by the first busbar frame 151 and electrically connected to the first lead tab portion 111, and a second busbar 172 supported by the second busbar frame 152 and electrically connected to a second lead tab portion 112.

The first busbar 171 and the second busbar 172 may be located further away from the plurality of battery cells 110 than the first busbar frame 151 and the second busbar frame 152, respectively. That is, it may be located closer to the body side surfaces 2191 and 2192 than the first busbar frame 151 and the second busbar frame 152. Therefore, the first lead tab portion 111 and the second lead tab portion 112 may be inserted into slit holes (not shown) formed in the first busbar frame 151 and the second busbar frame 152, respectively, to be electrically connected to the first busbar 171 and the second busbar 172. However, this is only an embodiment, and the first lead tab portion 111 and the second lead tab portion 112 may be electrically connected to the first busbar 171 and the second busbar 172 in a different manner, respectively.

Meanwhile, the battery assembly 200 may further include a heat dissipation part 295 positioned between the body bottom surface 2194 and the plurality of battery cells 110 to transfer heat generated in the plurality of battery cells 110 to the outside of the battery assembly 200. The heat dissipation part 295 may be made of an adhesive material having thermal conductivity, for example, a heat dissipating adhesive. Therefore, the plurality of battery cells 110 may be bonded to the body bottom surface 2194 through the heat dissipation part 295. To this end, the heat dissipation part 295 may be sprayed or applied onto the body bottom surface 2194.

FIG. 3 illustrates a battery assembly 200 according to the present disclosure from above.

The busbar assembly 150 may include a first busbar 171 electrically connected to the first lead tab portion 111 and a first busbar frame 151 supporting the first busbar 171, respectively. The first busbar 171 and the first busbar frame 151 may be collectively referred to as a first busbar assembly 1501. That is, the first busbar assembly 1501 is electrically connected to the first lead tab portion 111, and may serve to support the cell stack 100.

The busbar assembly 150 may further include a second busbar 172 electrically connected to the second lead tab portion 112 and a second busbar frame 152 supporting the second busbar 172, respectively. The second busbar 172 and the second busbar frame 152 may be collectively referred to as a second busbar assembly 1502. That is, the second busbar assembly 1502 is electrically connected to the second lead tab portion 112, and can support the cell stack 100 together with the first busbar assembly 1501.

Referring to FIG. 3, the battery assembly 200 may include an insertion space 288 formed between the accommodation case 210 and the plurality of battery cells 110.

Alternatively, the insertion space 288 may be formed between the busbar 170 and the plurality of battery cells 110.

Alternatively, an empty space (hereinafter referred to as an insertion space 288) may be formed between the plurality of battery cells 110 and the busbar assembly 150 due to the electrical connection between the lead tab portions 111 and 112 and the busbar assembly 150.

In other words, a part of the receiving space 280 formed inside the accommodation case 210 may be a space for accommodating the plurality of battery cells 110, and the other part of the receiving space 280 may be space for the insertion space 288.

Specifically, the insertion space 288 is a space formed by each main body 115, each lead tab portion 111, 112, and the busbar 170. Normally, thermal runaway occurs in any one of the plurality of battery cells 110, and when off-gas occurs, high-temperature heat can be propagated to other adjacent battery cells through the insertion space 288. In order to prevent such thermal propagation, it is necessary to fill or fill the above insertion space 288.

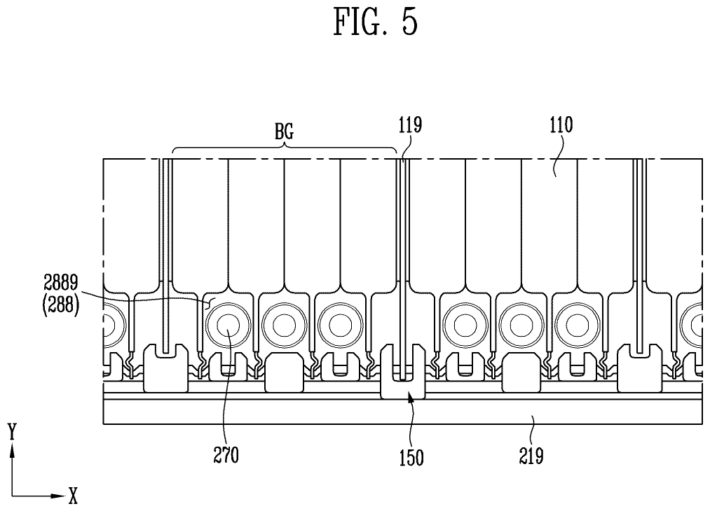

To this end, the battery assembly 200 according to the present disclosure may include a thermal delay assembly (or fire-retardant assembly, 270, see FIG. 5) inserted into the insertion space 288.

That is, the battery assembly 200 according to the present disclosure includes the plurality of battery cells 110 stacked and arranged in a predetermined stacking direction, the accommodation case 210 accommodating the plurality of battery cells 110, the insertion space 288 formed between the plurality of battery cells 110 and the accommodation case 210 along the stacking direction, and the thermal delay assembly 270 located in the insertion space 288. Meanwhile, referring to FIG. 3, the buffer member 117 may be positioned between the plurality of battery cells 110. The buffer member 117 may be provided between each of the plurality of battery cells 110. Alternatively, the buffer member 117 may be located between battery groups BG1 to BG5 (see FIG. 10) in which adjacent battery cells 110 are grouped into a predetermined number of groups.

Referring to FIG. 3, the length of the buffer member 117 along the direction from the first busbar frame 151 toward the second busbar frame 152 is shown to be less than or equal to the length of the main body 115 (see FIG. 1), but is not limited thereto.

Meanwhile, referring to FIG. 3, the heat blocking member 119 may be positioned between the plurality of battery cells 110. The heat blocking member 119 may be provided between each of the plurality of battery cells 110. Alternatively, the heat blocking member 119 may be located between battery groups BG1 to BG5 in which adjacent battery cells 110 are grouped into a predetermined number of groups.

The battery groups BG1 to BG5 refer to a set of battery cells in which adjacent battery cells 110 among the plurality of battery cells 110 are grouped into a predetermined number of groups. The plurality of battery cells 110 may be grouped into the group number for a predetermined target voltage or target current, and then the battery groups BG1 to BG5 may be connected in series or in parallel by using the busbar 170.

Referring to FIG. 3, the length of the buffer member 117 along the direction from the first busbar frame 151 toward the second busbar frame 152 is shown to be less than or equal to the length of the main body 115 (see FIG. 1), but is not limited thereto.

On the other hand, referring to FIG. 3, the heat blocking member 119 and the buffer member 117 are shown as separate members, but alternatively, as described above, they may be formed as one member. This may be referred to as a thermal delay assembly (not shown).

That is, the thermal delay assembly may be positioned between the plurality of battery cells 110 to buffer the surface pressure of the battery cells during thermal runaway, mitigation of thermal propagation, and swelling.

Meanwhile, the length of the heat blocking member 119 along the direction from the first busbar frame 151 toward the second busbar frame 152 may be longer than the length of the main body 115. More specifically, the heat blocking member 119 may be in contact with the first busbar assembly 1501 and the second busbar assembly 1502. As a result, the heat blocking member 119 may block or delay the propagation of heat or flame to other locations when any battery cell 110 is thermally runaway.

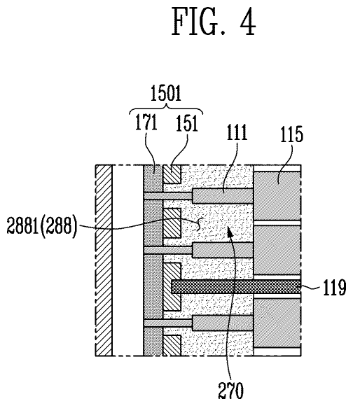

FIG. 4 is an enlargement of part S1 of FIG. 3.

Specifically, the part S1 may be a partial area of the insertion space 288. The battery assembly 200 may further include an insertion space 288 formed between the cell stack 100 and the busbar assembly 150 or the plurality of battery cells 110 and the busbar 170.

Specifically, the battery assembly 200 may include a first insertion space 2881 and a second insertion space 2882 (see FIG. 3) between the first busbar 171 and one side of each of the main body 115 of the plurality of battery cells 110, and between the second busbar 172 and the other side of the main body 115 of each of the plurality of the battery cells 110.

Referring to FIGS. 3 and 4, the thermal delay assembly 270 may be located in at least one of the first insertion space 2881 or the second insertion space 2882. In FIG. 4, only the position of the thermal delay assembly 270 is indicated to emphasize that it is located in the insertion space 288, and the shape of the thermal delay assembly 270 is not specifically shown.

That is, the thermal delay assembly 270 may be located in at least one of the first insertion space 2881, the second insertion space 2882, and the second insertion space 2882.

More specifically, part S1 of FIG. 4 shows a part of the first insertion space 2881. One side surface of the main body 115 may be a side surface where the first lead tab part 111 is located, and the other side surface of the main body 115 may be the side surface where the second lead tab part 112 is located.

Meanwhile, the space of the first insertion space 2881 may be separated by the first lead tab portion 111. In addition, the second insertion space 2882 may be separated by the second lead tab portion 112. However, when the cell stack 100 is accommodated in the receiving body 219, the lengths of the first lead tab portion 111 and the second lead tab portion 112 along the height direction of the accommodation case 210 or the receiving body 219 are smaller than the height of the battery cell 110, so that the first insertion space 2881 and the second insertion space 2882 may communicate with each other.

In addition, the first insertion space 2881 and the second insertion space 2882 may communicate with each other through a space between the plurality of battery cells 110 and the receiving cover 215. Therefore, the first insertion space 2881 and the second insertion space 2882 may not be separated and isolated from each other, but may be spaces capable of communicating with each other.

FIG. 5 schematically illustrates an embodiment of a thermal delay assembly 270 received in the insertion space 288 as seen above.

The battery assembly 200 may have an insertion space 288 formed between the plurality of battery cells 110 and the busbar assembly 150 (or the busbar 170). The insertion space 288 may be formed by connecting each lead tab portion 111, 112 with the busbar assembly 150 (or the busbar 170).

Meanwhile, the insertion space 288 may include a plurality of separation spaces 2889 separated by the respective lead tab portions 111 and 112. Each of the lead tab portions 111, 112 does not separate the plurality of separation spaces 2889 in an isolated manner. That is, since the length of each of the lead tab portions 111 and 112 along the height direction of the accommodation case 210 is smaller than the height of the housing space 280, only at least a part thereof is distinguished along the height of the receiving space 280.

That is, the plurality of insertion spaces 288 may be separated or communicated with each other by the respective lead tab portions 111, 112 because the length of each lead tab portion 111, 112 along the height direction of the accommodation case 210 is smaller than the length of each main body 115.

More specifically, the plurality of first insertion spaces 2881 may be formed by the first lead tab portion 111, and the plurality of first insert spaces 2881 may communicate with each other. Similarly, the plurality of second insertion spaces 2882 may be formed by the second lead tab portion 112, and the plurality of second insert spaces 2882 may communicate with each other.

Thus, as described above, the plurality of separation spaces 2889 may be in communication with each other. In addition, a plurality of the thermal delay assemblies 270 may be provided and inserted into the plurality of separation spaces 2889, respectively.

Meanwhile, referring to FIG. 5, the battery assembly 200 may further include a heat blocking member 119 positioned between the plurality of battery cells 110. Alternatively, the battery assembly 200 may further include a heat blocking member 119 positioned between the battery groups BG in which the plurality of battery cells 110 are grouped.

Referring to FIG. 5, the heat blocking member 119 may be provided in parallel with the plurality of battery cells 110 and extend to the busbar assembly 150. More specifically, the train disconnection member 119 may extend to and be inserted into the busbar frame 151, 152. In this case, the thermal delay assembly 270 may not be inserted into the space into which the heat blocking member 119 is inserted. This is to prevent interference between the thermal delay assembly 270 and the heat blocking member 119.

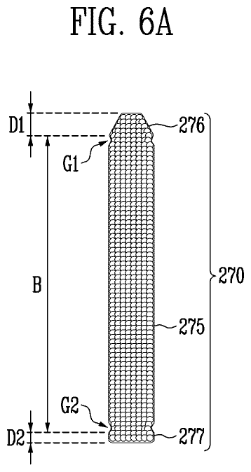

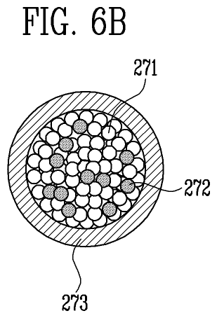

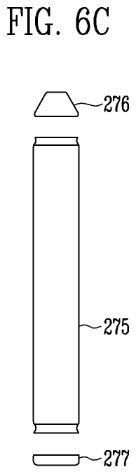

FIG. 6A illustrates an embodiment of a thermal delay assembly 270 received in an insertion space 288. FIG. 6B shows one side of the thermal delay assembly 270 shown in FIG. 6A. FIG. 6C is an exploded view of an embodiment of the housing member 273.

As described above, the battery assembly 200 according to the present disclosure may include a plurality of battery cells 110 stacked and arranged in a predetermined stacking direction, an accommodation case 210 accommodating the battery cells 110, an insertion space 288 formed between the battery cells 110 and the accommodation case 210 along the stacking direction, and a thermal delay assembly 270 located in the insertion space.

Referring to FIGS. 6A and 6B, the thermal delay assembly 270 may include a fire-extinguishing member 272 and a housing member 273 that receives the fire-extinguishing members 272 therein.

The form of the fire-extinguishing member 272 may be a bead-shaped solid.

The housing member 273 may further include the fire-resistant member 271. That is, the housing member 273 may include the fire-extinguishing member 272 and the fire-resistant member 271 therein.

Alternatively, the fire-extinguishing member 272 may be a liquid. That is, if the fire-extinguishing member 272 can generate fire-extinguishing gas, the phase of the fire-extinguishing member 272 may be solid or liquid.

In addition, the fire-extinguishing member 272 may generate a fire-extinguishing gas at a predetermined first temperature.

The housing member 273 may extend along the height direction of the accommodation case. Therefore, the housing member 273 may have a columnar shape.

For example, the housing member 273 may be in the form of a capsule. Thus, the thermal delay assembly 270 may be referred to as a Fire-retardant Capsule (FR Capsule).

Meanwhile, the thermal delay assembly 270 may further include a fire-resistant member 271 having a bead shape made of a fire-resistant material mixed with the fire-extinguishing member 272.

The mixing ratio of the fire-extinguishing member 272 and the fire-resistant member 271 may vary depending on the use environment. That is, only the fire-extinguishing member 272 may be used without the fire-resistant member 271, or alternatively, only the fire-resistant members 271 may be used without any of the fire-extinguishing members 272. Therefore, the mixing ratio between the fire-extinguishing member 272 and the fire-resistant member 271 can vary from 0 to 100 to 100 to 0. Meanwhile, the height of the thermal delay assembly 270 along the height direction of the accommodation case 210 may be greater than the length (or diameter) of the thermal delay assembly 270 along the stacking direction. That is, the thermal delay assembly 270 may have a cylindrical shape formed to extend along the height direction of the accommodation case 210.

In addition, considering the size of the insertion space 288, the length (or diameter) of the thermal delay assembly 270 along the stacking direction may be less than or equal to the thickness of any one of the plurality of battery cells. This is to facilitate insertion of the thermal delay assembly 270 into the insertion space 288.

A length of the housing member 273 along a height direction of the accommodation case 210 is longer than a length of the housing member 273 along the stacking direction of the accommodation case 210.

Preferably, the thermal delay assembly 270 may be cylindrical in shape. Thus, the length of the thermal delay assembly 270 along the stacking direction may refer to the diameter when the cross-section of the thermal delay assembly 270 is circular.

Meanwhile, at least one of both ends 276 and 277 of the thermal delay assembly 270 or the housing member 273 may be provided in a tapered shape.

This is to facilitate insertion of the thermal delay assembly 270 into the insertion space 288. That is, upon insertion of the thermal delay assembly 270 into the insertion space 288, at least one end of the thermal delay assemblies 270 may be tapered such that the thermal delay assembly 700 may be guided into the insertion space.

Referring to FIG. 6B, the housing member 273 may further include a fire-resistant space 274 formed by the housing member 273, and configured to receive the fire-resistant member 271 and/or the fire-extinguishing member 272.

While FIG. 6A illustrates an embodiment in which the shape of the housing member 273 is a columnar shape, FIG. 6C illustrates another embodiment in which the form of the housing member 273 is a rectangular parallelepiped shape. The shape of the housing member 273 is not limited thereto, and may be any shape as long as it can be inserted into the insertion space 288.

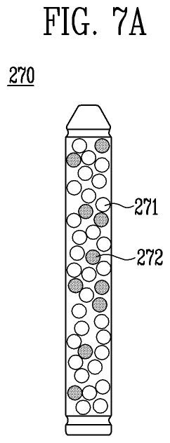

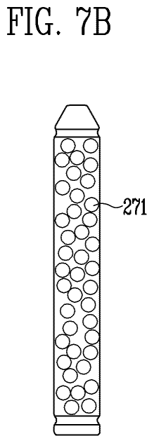

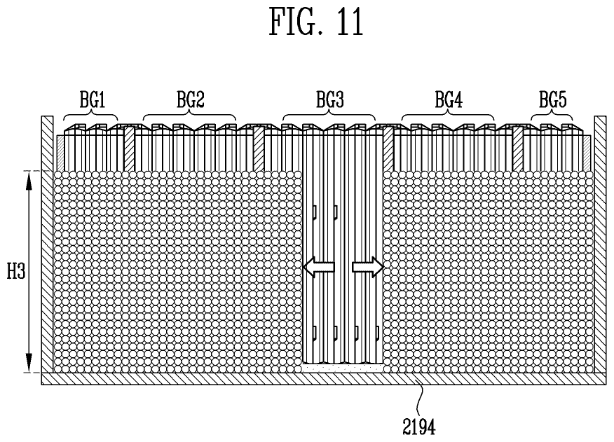

In FIG. 6A, FIG. 6B, FIG. 7 to FIG. 9, and FIG. 11, the fire-resistant member 271 and/or the fire-extinguishing member 272 are assumed to be spherical for convenience, but the shape of the fire-resistant members 271 is not limited to a spherical shape. Thus, the fire-resistant member 271 and/or the fire-extinguishing members 272 may have an amorphous shape. In addition, the fire-resistant member 271 and/or the fire-extinguishing member 272 may not be determined to be any one size, but may be a mixture of the fire-resistant members 271 and/or the fire-fighting members 272 of various sizes. Further, the fire-resistant member 271 and/or the fire-extinguishing member 272 are shown exaggerated in size for purposes of illustration.

Referring to FIG. 6C, the housing member 273 may include a body portion 275 having pipe shape and extending along the height direction of the accommodation case 210, a first end portion 276 coupled to an upper side of the body portion 275 to close one of both open ends of the body portion 275, and a second end portion 277 coupled to a lower side of the body portions 275 to close the other open end.

Alternatively, an end of any one of the first end portion 276 and the second end portion 277 of the housing member 273 may be integrally formed with the body portion 275. That is, the housing member 273 may include a columnar body portion 275 having one end open and either end portion 276 or 277 coupled to the one end.

Referring to FIGS. 6A and 6C, the length B of the body portion 275 may be longer than the length D1 of the first end portion 276 and the length D2 of the second end portion 277.

The body portion 275 may also have a cylindrical shape. The thermal delay assembly 270 may further include grooves G1 and G2 that are recessed inwardly along the circumferential surface of the cylindrical body portion 275. The grooves G1 and G2 may be formed between the first end portion 276 and the body portion 275, and between the second end portion 277 and the body portion 275. This is to prevent the battery cell 110 adjacent to the thermal delay assembly 270 from being damaged when the thermal delay assembly 170 is inserted.

Further, the first end portion 276 may be tapered away from the body portion 275.

That is, one end of at least one of both ends of the housing member may be tapered. This is to allow easy insertion of the thermal delay assembly 270 into the insertion space 288 using the tapered end.

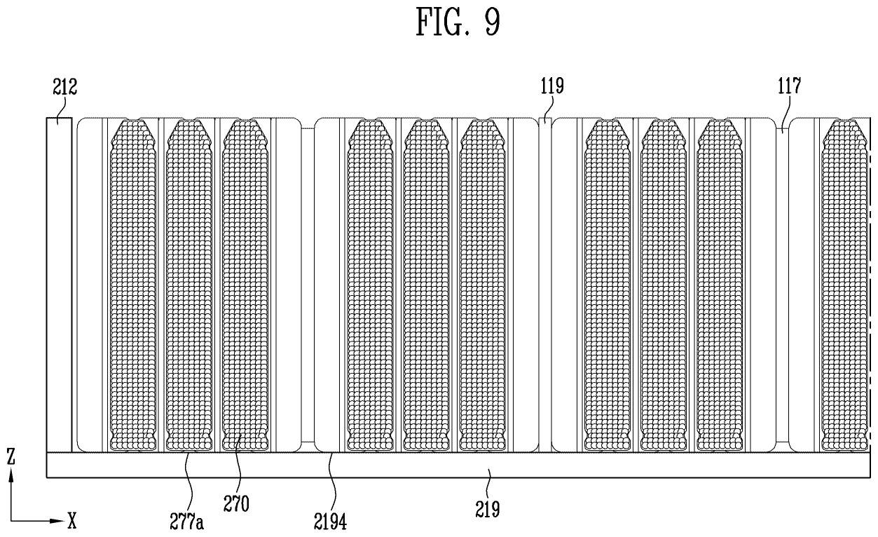

Alternatively, the second end 277 may comprise a flat end face. That is, the second end portion 277 may include an end face 277a (see FIG. 9) arranged in parallel with the body bottom surface 2194, which is the bottom face of the accommodation case 210.

Referring to FIGS. 6A and 6B, a plurality of the fire-resistant members 271 and/or the fire-extinguishing members 272 may be respectively provided, mixed with each other, and accommodated in the housing member 273.

The fire-resistant member 271 and/or the fire-extinguishing member 272 may be a solid filler provided in the form of solid particles, powders, grains, pellets or beads. This is to prevent or delay flame propagation or thermal propagation through the insertion space 288 during thermal runaway of any battery cell 110.

The size of the fire-resistant member 271 and/or the fire-extinguishing member 272 may be preferably greater than or equal to 2 μm (micrometers) and less than or equal to the length or thickness of one battery cell 110 along the stacking direction.

Preferably, the fire-resistant member 271 may have a micro size. Such a micro-sized fire-resistant member 271 may be referred to as a micro bead or a micro granular body.

The size of the fire-resistant member 271 and/or the fire-extinguishing member 272 may be the size of the diameter when assuming a spherical shape with the distance from the center (or center of gravity) of the fire-retardant member 271 and/or the fire-fighting member 272 to the farthest outer periphery as the radius.

Therefore, the size of the fire-resistant member 271 and/or the fire-extinguishing member 272 may be a maximum outer diameter of the fire-retardant member 271 and or the fire-extinguisher member 272. Alternatively, the size of the fire-resistant member 271 and/or the fire-extinguishing member 272 may be an average value calculated after the fire-resistant members 271 and/or the fire-extinguisher members 272 are removed from various directions.

The reason why the size of the fire-resistant member 271 and/or the fire-extinguishing member 272 should be 2 μm or more is to prevent the fire-resistant members 271 and/or 272 from escaping to a space other than the insertion space 288, for example, a space between the accommodation case 210 (see FIG. 1) and the busbar assembly 150 (see FIG. 2).

The lead tab portions 111, 112 (see FIG. 1) may be formed through the busbar 170 to be electrically connected to the busbar 170 (see FIG. 2). To this end, the busbar 170 may include a slit hole (not shown) formed through the busbar 170. The lead tab portions 111, 112 may be welded after being inserted into the slit hole. The slit hole will be closed by welding, whereby a weld bead (not shown) may be formed in the weld region of the slit hole. The weld bead is a unique shape that can occur during welding. The weld bead may also have fine voids, and since the size of the voids formed in the weld bead is about 2 μm, the size or outer diameter of the fire-resistant member 271 and/or the fire-extinguishing member 272 may be preferably 2 μm or more. This is because the fire-resistant member 271 and/or the fire-extinguishing member 272 can be prevented from escaping through the gap.

Preferably, the size of the fire-resistant member 271 and/or the fire-extinguishing member 272 may be greater than or equal to the size of the voids formed in the weld bead.

In addition, the size or outer diameter of the fire-resistant member 271 and/or the fire-extinguishing member 272 may be less than or equal to the length or thickness of one battery cell along the stacking direction. This is because the fire-resistant member 271 and/or the fire-extinguishing member 272 can be accommodated in the insertion space 288 (see FIG. 3) formed between the lead tab portions 111 and 112 only when the distance between the lead tab portion 111 and 112 is smaller than the distance between the other lead tab portion 111 or 112 adjacent to the lead tab portion 112.

For example, if the battery cell 110 has a thickness of 15 mm, the size or outer diameter of the fire-resistant member 271 may be 15 mm or less. In addition, the size of the housing member 273 should also be less than or equal to the thickness of the battery cell 110.

In other words, the size of the fire-resistant member 271 and/or the fire-extinguishing member 272 should be greater than or equal to the distance between one battery cell 110 of the plurality of battery cells 110 and the other battery cell 110 adjacent to the one battery cell 110 along the stacking direction, and may be less than or equal to a distance between the one lead tab portion 111, 112 and the one lead tab portions 111, 112 along the stacking directions.

In addition, the fire-resistant member 271 and/or the fire-extinguishing member 272 may not be determined to be any one of the same size or material, but may be a mixture of the fire-resistant members 271 and/or the fire-fighting members 272 of various sizes or various materials.

The fire-extinguishing member 272 may include one or more of phosphoric acid-based compounds such as monoammonium phosphate ((NH₄)H₂PO₄), diammonium phosphate ((NH₄)₂HPO₄), and potassium compounds such as potassium carbonate (K₂CO₃), or any combination thereof.

For example, the fire-extinguishing member 272 may include a potassium compound that is pyrolyzed at the first temperature to generate the fire extinguished gas. More specifically, the fire-extinguishing member 272 may include potassium carbonate. When the potassium carbonate is used, the fire-extinguishing member 271 may be in a liquid form instead of a solid form.

In addition, the raw material (or material) of the fire-extinguishing member 272 is not limited to the mentioned type. The materials of conventional fire-extinguishing powders and fire-extinguishing agents may be used as the materials of the fire-extinguishing member 272.

The potassium compound is thermally decomposed by heat at the above first temperature in the event of a fire to generate a fire-extinguishing gas, and the fire-extinguishing gases absorb O, H, and OH to break the combustion chain, thereby chemically extinguishing the above fire. Thus, the fire-extinguishing member 272 may effectively delay thermal propagation within the battery assembly 200.

The first temperature may be greater than or equal to the second temperature described below. This is because when the housing member 273 starts to melt at the second temperature, the fire-extinguishing member 272 must generate the above fire-extinguishing gas.

Meanwhile, the melting point of the fire-resistant member 271 may preferably be higher than a predetermined second temperature (or allowable temperature) to be described later. In addition, the melting point of the fire-resistant member 271 may be higher than the first temperature.

Preferably, the second temperature may be greater than or equal to 50° C. and less than or equal to 300° C. The housing member 273 may begin to melt upon reaching the second temperature. Therefore, the melting point of the fire-resistant member 271 should be higher than the second temperature.

In addition, the melting point of the fire-resistant member 271 may be higher than the ignition points of the plurality of battery cells 110. The ignition point of the plurality of battery cells 110 may be a temperature at which venting occurs in the battery cell 110. Alternatively, when the housing member (or accommodation case) of the battery cell 110 is torn or opened in a thermal runaway situation, the temperature of the electrolyte accommodated inside the battery cell 110, that is, inside the main body 115.

Therefore, when the thermal runaway of any one of the battery cells 110 starts, the housing member 273 melts and the fire-extinguishing member 272 generates a fire-extinguishing gas, but the fire-resistant member 271 can maintain a solid form. This is to prevent the fire-resistant member 271 from burning or melting.

For example, even if the thermal runaway of the battery cell 110 occurs, the fire-resistant member 271 may not burn or melt and the external shape of the fire-resistant members 271 may be maintained without significant change.

The fire-resistant member 271 may include a porous material. The term of porous material means a material that includes pores within a structure. The shape of the pores may be irregular and unstructured. Specifically, when the fire-resistant member 271 includes silica gel in the form of particles or powders, the porosity of the refractories member 271 may be 20 percent (%) or more and 30 percent (%) of or less.

The fire-resistant member 271 may include one or more of Alum (K₂SO₄·Al₂(SO₄)₃·24H₂O), borax (Na₂B₄O₇·10H₂O), lime water (Ca(OH)₂, aqueous solution), quicklime (CaO), a white emulsion made by mixing lime porridge (Milk of Lime Ca(OH)₂) with water), slaked lime (Ca(OH)₂), washing soda (Na₂CO₃·10H₂), apatite (Ca₅(PO₄)₃OH), baking powder (Baking Powder, a salt mixture of NaHCO₃ and tartaric acid), baking soda (Baking Soda, NaHCO₃), sodium thiosulfate pentahydrate (Na₂S₂O₃·5H₂O), silica (Silica, or silicon dioxide (SiO₂)), alumina (Alumina or aluminum oxide (Al₂O₃)), calcium oxide (CaO), calcium sulfate (CaSO₄), calcium chloride (CaCl₂)), sodium carbonate (Na₂CO₃), potassium chloride (KCl), magnesium oxide (MgO), zirconium oxide (ZrO2), chromium oxide (Cr₂O₃), aluminum hydroxide (Al(OH)₃), antimony trioxide (Sb₂O₃), antimonies pentoxide (Sb₂O₅), magnesium hydroxide (Mg(OH)₂), a zinc borate compound, a phosphorus-based compound, a nitrogen-based guanidine compound, or a molybdenum compound, or a mixture thereof.

As an embodiment, if it is assumed that the fire-resistant member 271 is formed of silica (silicon dioxide), considering the melting point of silica (1713° C. (Celsius temperature)), it is possible to minimize the propagation of heat or off-gas generated when thermal runaway occurs to other places. In addition, the shape of the fire-resistant member 271 will remain unchanged in the thermal runaway situation of the battery cell.

As another embodiment, the fire-resistant member 271 may be formed of silica gel. The silica gel is a porous material in the form of a powder made by treating an aqueous solution of sodium silicate (Na₂SiO₃) with an acid. Specifically, it can be obtained by mixing sodium silicate and an aqueous inorganic acid solution (such as sulfuric acid) to form a silica hydrosol and curing the hydrosol with a hydrogel. In view of the above-described conventional method of silica gel, the main component (component occupying 50% or more) of the silica gel is silicon dioxide, and other components may further include aluminum oxide, iron (III) oxide (Fe₂O₃, iron (III) Oxide, or ferric Oxide), or sodium. Therefore, the melting point of the silica gel may be approximately 1600° C. (Celsius temperature) or higher.

Preferably, the silica gel may contain at least 90 percent (%) silicon dioxide. In addition, since the silica gel is made of a porous material, the porosity of the fire-resistant member 271 may be 20 percent (%) or more and 30 percent (%) or less.

In addition, the fire-resistant member 271 may be formed of an aerogel. This is because aerogels not only have low thermal conductivity, but also have the property of retaining moisture and expanding in a high-humidity environment.

Considering that the fire-resistant member 271 is formed of a fire-resistant material such as silica gel, alumina gel, or aerogel, the fire-resistant material forming the fire-resistant members 271 may include silicon dioxide (SiO₂).

On the other hand, the fire-resistant member 271 may be formed of a material other than silica gel as long as it is a material having porosity and flame retardancy (heat resistance property or fire resistance property).

As another embodiment, the fire-resistant member 271 may mean a polymer material having a V-0 grade in the 94V (Vertical Burning Test) of the UL (Underwriter's Laboratory), which is a flame retardant standard for a polymer material.

Specifically, the fire-resistant member 271 may include a flame-retardant compound. The flame-retardant material includes a phosphorus-based, halogen-based, or inorganic flame retardant, and preferably, in the case of a phosphorus-based flame retardant material, a phosphate compound, a phosphonate compound, a phosphinate compound, a podphine oxide compound, a phorsphazene compound, a metal salt thereof, or the like may be included. They may be used alone or in combination of two or more kinds.

In another specific embodiment, the phosphorus-based flame retardant may be, but is not limited to, diphenyl phosphate, diaryl phosphate, triphenyl phosphate, tricresyl phosphate, trixyrenyl phosphate, tri(2,6-dimethylphenyl)phosphate, tri(2,4,6-trimethylphenyl)phosphates, tri(2,4-ditertiarybutylphenyl)phosphate, tri(2,6-dimethylphenyl)phosphate, bisphenol-A-bis(diphenylphosphate), resorcinol bis(diphenyl phosphate), resorcinol bis [bis(2,6-dimethylphenyl)phosphate], resorcinol bis [bis(2,4-ditertiarybutylphenyl)phosphate], hydroquinone bis [bis(2,6-dimethylphenyl)phosphate], hydroquinone bis [bis(2,4-ditertiarybutylphenyl)phosphate], oligomeric phosphate ester-based compound. They may be applied alone or in the form of a mixture of two or more.

The housing member 273 may be melted at a predetermined second temperature or higher. That is, when a thermal runaway occurs in at least one battery cell 110 among the plurality of battery cells 110 and the temperature rises, the temperature around the battery cell 110 in which the thermal runaway occurs will rise. At this time, when the temperature of the housing member 273 reaches the second temperature, the housing member 272 may start to melt. Thereafter, when the temperature rises further and reaches the first temperature, a fire-extinguishing gas may be generated in the fire-extinguishing member 272.

When the housing member 273 starts to melt at or above the second temperature, the fire-resistant member 271 may move freely in the insertion space 288.

The housing member 273 may be formed of a material that melts at or above the second temperature while accommodating the fire-resistant member 271. More specifically, the housing member 273 may be formed of a heat-resistant (refractory or flame-retardant) material that does not melt to the second temperature. For example, the housing member 273 may be formed of a polymer such as polypropylene (PP), polyethylene (PE), rubber, cellulose, or resin. Alternatively, the housing member 273 may be formed of a foam-like polymer.

The housing member 273 may allow the thermal delay assembly 270 to maintain a constant shape regardless of the shape of the fire-resistant member 271. Even when the fire-resistant member 271 is in a liquid state, the thermal delay assembly 270 may maintain a predetermined three-dimensional shape by the housing member 273.

In addition, by obtaining the effect that the outer surface of the thermal delay assembly 270 is coated with the housing member 273, it is possible to improve the moisture resistance effect or the moisture proof effect of the thermal delay assembly 270.

FIG. 7A illustrates another embodiment of a thermal delay assembly 270 received in an insertion space 288. FIG. 7B illustrates another embodiment of a thermal delay assembly 270 received in an insertion space 288.

Referring to FIG. 7A, an embodiment is shown in which the fire-extinguishing member 272 and the fire-resistant member 271 are mixed and accommodated in a certain ratio in the housing member 273.

In contrast, FIG. 7B illustrates an embodiment in which the interior of the housing member 273 is filled only with the fire-extinguishing member 272.

Referring to FIGS. 7A and 7B, in the thermal delay assembly 270, the fire-extinguishing member 272 and the fire-resistant member 271 may be used alone or may be mixed at an appropriate mixing ratio.

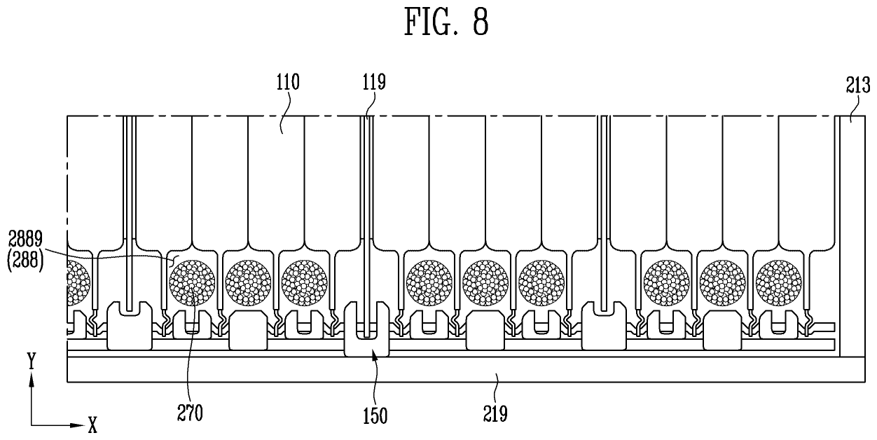

FIG. 8 is a top view of an embodiment of a battery assembly according to the present disclosure from above.

Referring to FIGS. 2 and 8, FIG. 8 shows a portion of the receiving body 219 viewed from above after removing the receiving cover 215 (specifically, a region where the receiving body 218 and either of the endplates 212 and 213 meet).

As described above, the movement of the fire-resistant member 271 and/or the fire-extinguishing member 272 is suppressed by the housing member 273, and at least a part of the fire-resisting member 271 may be released from restraint engagement by the housing member 273 as the housing member 273 melts.

Referring to FIG. 8, the insertion space 288 is divided into a plurality of separation spaces 2889 (see FIG. 5), and a plurality of thermal delay assemblies 270 may be inserted into at least some of the separation spaces 2889.

The battery assembly 200 may further include a heat blocking member 119 positioned between the battery cells 110 along a stacking direction (e.g., X direction) of the plurality of battery cells 110. The heat blocking member 119 extends in a direction (e. g., Y direction) in which the lead tab portions 111 and 112 protrude from a direction perpendicular to the stacking direction, and is connected to the busbar assembly 150. Therefore, the plurality of separation spaces 2889 may not be fully filled with the thermal delay assembly 270.

However, in the absence of the heat blocking member 119, each of the thermal delay assemblies 270 may be inserted into all of the plurality of separation spaces 2889.

FIG. 9 illustrates one aspect of an embodiment of a battery assembly according to the present disclosure.

Specifically, referring to FIGS. 2 and 9, FIG. 9 illustrates an area adjacent to either of the endplates 212, 213 when looking at the battery assembly 200 after removing the body sides 2191, 2192 and the busbar assembly 150.

Referring to FIGS. 1, 2, and 9, the insertion space is located outside the plurality of battery cells 110 and is separated into a plurality of separation spaces 2889 by respective lead tab portions 111 and 112 connecting the busbar 170 and the plurality of battery cells 110, and the thermal delay assembly 270 is provided in a plurality and may be inserted into at least a part of the plurality of separation spaces 2789.

FIG. 9 illustrates an embodiment in which the plurality of thermal delay assemblies 270 are inserted one by one corresponding to the plurality of separation spaces 2889, but may be disposed in at least a part of the plurality of separation space 2889. If the thermal delay assembly 270 is capable of delaying thermal runaway of the battery cell 110, the thermal delay assembly 700 need not necessarily be located in each of the plurality of separation spaces 2889.

Meanwhile, referring to FIG. 9, the plurality of thermal delay assemblies 270 may have different ratios of the fire-extinguishing member 272 and the fire-resistant member 271 that are filled in the respective housing members 273. This is due to the high frequency of thermal runaway in the battery assembly 200.

For example, the thermal delay assembly 270 located adjacent to the battery cell 110 located in the middle region of the plurality of battery cells 110 may include only the fire-extinguishing member 272. On the other hand, the thermal delay assembly 270 located adjacent to the battery cell 110 located in the edge region among the plurality of battery cells 110 may include only the fire-resistant member 271.

Referring to FIGS. 2 and 9, the accommodation case 210 includes an open upper surface 2195, and may further include a receiving body 219 configured to receive the plurality of battery cells 110 through the open upper surface 2195, and a receiving cover 215 coupled to the receiving body 219 to cover the open upper surface 2295.

In addition, one end of the thermal delay assembly 270 or the housing member 273, which is closer to the receiving cover 215 than the receiving body 219, may have a tapered shape.

FIG. 10 shows a schematic form in which the housing member 273 is melted and the fire-resistant member 271 and/or the fire-extinguishing member 272 are stacked in a piece in the insertion space 288.

Specifically, FIG. 10 illustrates an embodiment in which the housing member 273 is melted above the second temperature to separate the fire-resistant member 271 and/or the fire-extinguishing member 272 into pieces and fill the insertion space 288 to a predetermined filling height H1 along the height direction of the accommodation case 210 or the housing body 219.

If the temperature is equal to or higher than the first temperature, the fire-extinguishing member 272 may be decomposed to generate a fire-extinguishing gas, leaving only the fire-resistant member 271. That is, when the fire-extinguishing member 272 starts to be decomposed, the ratio of the fire-resistant member 271 will gradually increase over time.

The insertion space 288 is divided into a plurality of separation spaces 2889, and a plurality of thermal delay assemblies 270 may be inserted into at least some of the separation spaces 2889. The volume of each of the insertion spaces 288 may be greater than the sum of the volumes of each of the thermal delay assemblies 270 inserted into the plurality of separation spaces 2889.

As a result, even if it is assumed that all of the housing members 273 are melted during thermal runaway of the plurality of battery cells 110, the fire-resistant member 271 and/or the fire-extinguishing member 272 may not be able to fill the insertion space 288 to the uppermost end in the height direction of the battery cell 110.

That is, assuming that the battery assembly 200 reaches the second temperature and the housing member 273 is all melted, the fire-resistant member 271 and/or the fire-extinguishing member 272 may fill the insertion space 288 to the filling height H1 in the form of a piece or a part of a bundle.

Referring to FIG. 10, the filling height may be a height indicated by H1 from the body bottom surface 2194, which is the bottom surface of the receiving body 219.

For example, the filling height H1 shown in FIG. 10 shows an embodiment of a height corresponding to when 50% of the volume of the insertion space 288 is filled with the fire-resistant member 271 and/or the fire-extinguishing member 272 after the housing member 273 is melted.

Meanwhile, the battery assembly 200 may further include a heat dissipation part 295 between the plurality of battery cells 110 and the body bottom surface 2194. The heat dissipation part 295 may be a material that is first applied as a liquid to the body bottom surface 2194 before the plurality of battery cells 110 are accommodated, and then hardens when a predetermined elapsed time elapses after the plurality of battery cells 110 are accommodated.

On the other hand, the thickness of the heat dissipation part 295 may be negligible compared to the height of the receiving body 219 or the filling height H1.

Meanwhile, in the battery assembly 200, end plates 212 and 213 may be located at both ends of the plurality of battery cells 110 along the stacking direction. In addition, the plurality of battery cells 110 may form battery groups BG to BG5 by grouping some adjacent battery cells 110. A plurality of battery cells 110 in one battery group may be arranged in the same polarity and connected in parallel. Therefore, each battery group BG to BG5 may have a different pole arrangement from the adjacent battery group BG or BG5.

In addition, the battery assembly 200 may further include a heat blocking member 119 (see FIG. 3) or a buffer member 117 between the plurality of battery groups BG to BG5.

FIG. 11 illustrates an embodiment in which the fire-resistant member 271 and/or the fire-extinguishing member 272 move in the insertion space 288 due to flame or high temperature gas.

Referring to FIG. 11, when the housing member 273 restraining the fire-resistant member 271 and/or the fire-extinguishing member 272 starts to melt at the second temperature or higher, the fire-resistant members 271 and/or the fire-extinguished members 272 may be sequentially stacked from the body bottom surface 2194 by gravity.

In other words, since the fire-resistant member 271 and/or the fire-extinguishing member 272 are accommodated in the housing member 273, when the housing member 273 is removed, the fire-resistant members 271 and/or the fire-fighting members 272 will not be coupled to each other, but will be stacked in the insertion space 288.

FIG. 11 briefly illustrates an embodiment in which the housing member 273 of all of the thermal delay assemblies 270 inserted into the insertion space 288 is melted. The shape of the fire-resistant member 271 and/or the fire-extinguishing member 272 is exaggerated in size for the purpose of description, and is merely a spherical shape. In addition, for convenience, it is assumed that all the housing members 273 are in a molten state.

Alternatively, the housing member 273 may be first melted in the insertion space 288 where the battery cell 110 is located in one battery cell 110. Accordingly, some of the plurality of thermal delay assemblies 270 may be melted and others may retain the three-dimensional shape of the heat delay assembly 270.

In addition, in either thermal delay assembly 270, some areas may be melted, while others may still retain the appearance of the thermal delay assembly 270.

When the temperature of the thermal delay assembly 270 reaches the second temperature or higher, the housing member 273 starts to melt, and as shown in FIGS. 10 and 11, the fire-resistant member 271 and/or the fire-extinguishing member 272 may be freely stacked.

Meanwhile, a plurality of the fire-resistant members 271 and/or the fire-extinguishing members 272 may be provided.

Since the housing member 273 restraining the fire-resistant member 271 and/or the fire-extinguishing member 272 has been removed, the fire-resistant members 271 and/or the fire-fighting members 272 can move freely. Therefore, due to the flow of flame or off-gas generated during thermal runaway, the fire-resistant member 271 and/or the fire-extinguishing member 272 may be moved to another position under force.

As the temperature rises, the fire-extinguishing member 272 may disintegrate and disappear while generating fire-extinguishing gas. Consequently, only the fire-resistant member 271 may remain and fill the insertion space 288.

As described above, since the plurality of insertion spaces 288 are in communication with each other, the fire-resistant member 271 and/or the fire-extinguishing member 272 may move from the insertion space 288 corresponding to the battery cell 110 in which the thermal runaway has occurred to the other insertion space 288 when a flame propagates from one insertion space 288 in which the battery cell 110 having the thermal runaway is located toward the other battery cell 110 or when off-gas is moved (arrow direction).

For example, referring to FIG. 11, when a thermal runaway occurs in one battery cell (e.g., one battery cell belonging to BG3), the temperature of a region adjacent to the one battery cell will first rise. Therefore, the housing member 273 of the thermal delay assembly 270 adjacent to any one of the battery cells 110 where the thermal runaway has occurred may melt. Therefore, the fire-resistant member 271 and/or the fire-extinguishing member 272 that have been restrained by the melted housing member 273 can be freely movable.

Thus, if a flame or hot gas spreads to an adjacent battery group, the fire-resistant member 271 and/or the fire-extinguishing member 272 can move sideways along the flame or hot gas. FIG. 11 shows this briefly for the sake of explanation. As a result, the fire-resistant member 271 and/or the fire-extinguishing member 272 will be moved and filled in the remaining space of the insertion space 288 in which the flame or the high-temperature gas has not yet spread, so that the propagation of the flame or the low-temperature gas can be more effectively delayed.

In other words, when the housing member 273 is melted, the fire-resistant member 271 and/or the fire-extinguishing member 272 may move to the insertion space 288 corresponding to the position of the normally operable battery cell 110 where thermal runaway does not occur due to the pressure generated when thermal runaway occurs in any one of the plurality of battery cells 110. After the movement, the fire-extinguishing member 272 has not yet reached the first temperature and performs the same function as the fire-resistant member 271. As the temperature increases, the fire oxidizing member 272 decomposes to generate a fire-extinguishing gas. Therefore, the form in which the fire-resistant members 271 are mixed with the fire-extinguishing members 272 may more effectively delay thermal runaway or thermal propagation of the battery cell 110 than when only the fire-resistant parts 271 are present.

Therefore, referring to FIG. 11, the fire-resistant member 271 and/or the fire-extinguishing member 272 may move to a region other than the insertion space 288 corresponding to the region of the third battery group BG3. Therefore, the filling height H3 of the fire-resistant member 271 and/or the fire-extinguishing member 272 may be higher than the filling height H1 of the fire-retardant member 271 and or the fire-extinguisher member 272 in FIG. 10.

This is merely an embodiment, and the filling height H3 of the fire-resistant member 271 and/or the fire-extinguishing member 272 may vary depending on the propagation speed of the flame and the venting speed of the off-gas.

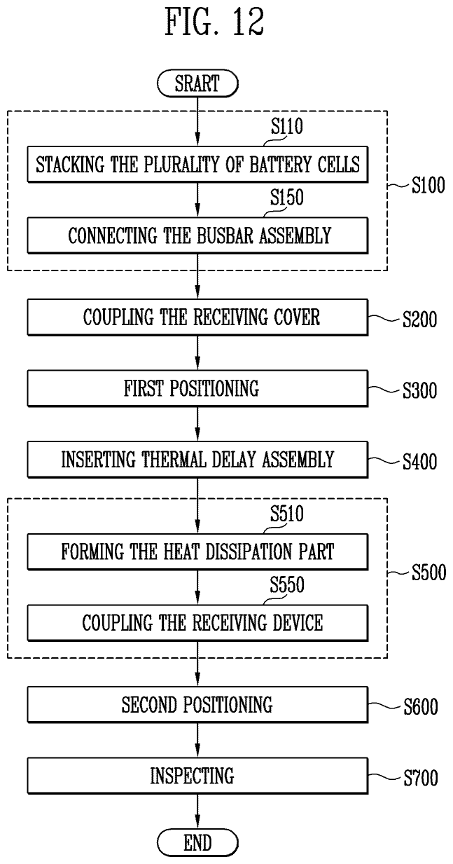

FIG. 12 is a flowchart illustrating an embodiment of a manufacturing process of the battery assembly 200 according to the present disclosure.

Referring to FIG. 12, a method of assembling a battery assembly 200 according to the present disclosure includes: stacking a plurality of battery cells 110 along a predetermined stacking direction (S110); coupling the stacked battery cells 110 to a receiving cover 215 (S200); inserting the thermal delay assembly 270 including a bead-shaped fire-resistant member 271 made of a fire-resistant material into the insertion space 288, a fire-extinguishing member 272 having a bead-shape that starts generating a fire-extinguishing gas at a predetermined first temperature, and an housing member 273 that receives the fire-resistant member 271 and the fire-extinguishing members 272 therein and extends along a height direction of the accommodation case 210 (S400); and coupling a receiving body 219 that is coupled to the receiving cover 215 to form the accommodation case 210 to the receiving cover 215 (S500).

The method for cooking the battery assembly 200 according to the present disclosure may include, after the step S110 of stacking the plurality of battery cells 110, the step S150 of coupling the busbar assembly 150, or the busbar assembly, electrically connected to the plurality of battery cells 110.

The step S110 of stacking the plurality of battery cells 110 and the step S150 of joining the busbar assembly 150 may be collectively referred to as the step S100 of assembling the cell stack 100.

Specifically, the step S100 of assembling the cell stack 100 may further include, after the step S110 of stacking the plurality of battery cells 110, a stacking step (not shown) of stacking the buffer member 117 and/or the heat blocking member 119 located between the plurality of battery cells 110 and the plurality of battery cells 110.

In addition, the step S100 of assembling the cell stack 100 may further include a step (not shown) of stacking end plates 212 and 213 located at both ends of the plurality of battery cells 110 along a stacking direction in which the plurality of battery cells 110 are stacked.

Meanwhile, the step S100 of assembling the cell stack 100 may further include a step S150 of connecting the busbar assembly 150 to the stacked battery cells 110 after the stacking step S110 is finished. The plurality of battery cells 110 and the busbar assembly 150 may be welded and electrically connected through the step S150 of connecting the busbar assemblies 150.

Thereafter, the assembly method of the present disclosure may include a step S200 of coupling the receiving cover 215 to the cell stack 100. The reason why the receiving cover 215 is assembled before the housing body 219 is to protect the busbar assembly 150 positioned facing the housing cover 225 during the assembly process.

Thereafter, the assembly method of the present disclosure may undergo a first positioning step S300 of changing the top and bottom of the battery assembly 200 being assembled. That is, the assembly method of the present disclosure may further include, prior to the step S400 of inserting the thermal delay assembly 270 into the insertion space 288, a first positioning step S300 of positioning the plurality of stacked battery cells 110 after coupling them to the receiving cover 215.

The reason for positioning the battery assembly 200 being assembled is to position the thermal delay assembly 270 in the insertion space 288. Since it is difficult to insert the thermal delay assembly 270 from above due to the already coupled receiving cover 215, the battery assembly 200 being assembled is turned over to position the thermal delay assembly 700.

The assembly method of the present disclosure may proceed to step S400 of inserting the thermal delay assembly 270 into the insertion space 288 after the first positioning step S300.

Thereafter, the assembly method of the present disclosure may further include a step S500 of coupling the receiving body 219 to the receiving cover 215.

The step of coupling the receiving body to the receiving cover (S500) may include, after the first positioning step (S300), coupling the receiving body 219 to the receiving cover 215 and the cell stack 100 in the positioning state (S550).

In addition, in the assembly method of the present disclosure, the step S500 of coupling the receiving body 219 to the receiving cover 215 may further include the step S510 of forming the heat dissipation part 295 on the body bottom surface 2194 forming the bottom surface of the receiving body 217 prior to the step S550 of coupling the receiving device 219 to the inverted receiving cover 215 and the cell stack 100.

The heat dissipation part 295 is formed on the body bottom surface 2194, and may contact the cell stack 100 when the cell stack 100 is coupled to the receiving body 219.

After the receiving body 219 and the receiving cover 215 are engaged, the assembly method of the present disclosure may include a second positioning step S600 of re-positioning the battery assembly 200 such that the receiving cover 225 is positioned thereon.

The assembly method of the present disclosure may then perform the step of inspecting (S700) the battery assembly 200.

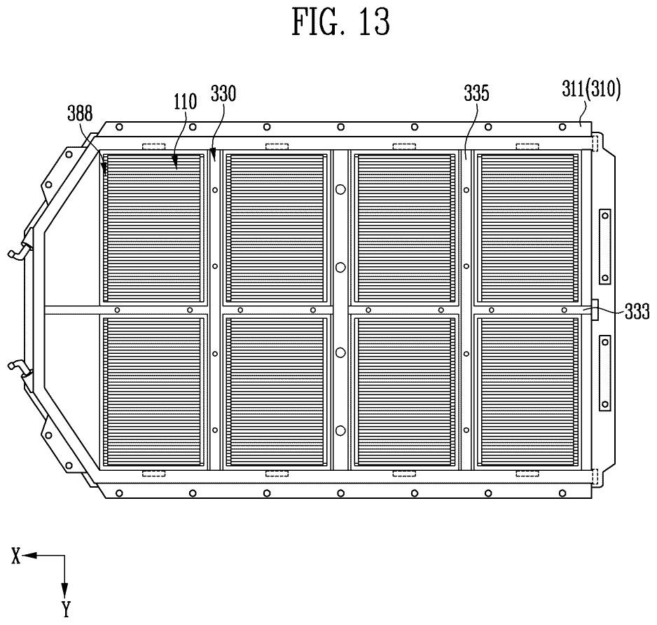

FIG. 13 illustrates another embodiment of a battery assembly 300 according to the present disclosure.

Although the battery assembly 200 described above is based on a battery assembly, FIG. 13 illustrates another embodiment of a battery assembly 300 provided in the form of a battery pack. That is, the battery assembly 200 may be in the form of a CTP (Cell to Pack) structure in which a plurality of battery cells 110 are directly accommodated in the form of packs without the battery assembly.

The battery assembly 300 includes a plurality of battery cells 110 stacked and arranged in a predetermined stacking direction, an accommodation case 310 accommodating the plurality of battery cells, an insertion space 388 formed between the plurality of battery cells 110 and the accommodation case along the stacking direction, and a thermal delay assembly (not shown) located in the insertion space.

The thermal delay assembly 270 (see FIG. 6A) includes a fire-resistant member 271 and a housing member 273 (see FIG. 6A) that accommodates the fire-resistant members 271 therein. In FIG. 11, the above-described thermal delay assembly 270 is omitted to describe the above-described accommodation case 210.

The accommodation case 310 may include a receiving body 311 for receiving the plurality of battery cells 110 and a receiving cover (not shown) coupled to the receiving body 311. The accommodation case 310 may further include a partition 330 that partitions the insertion space 388.

The partition 330 may further include a first frame 333 and a second frame 335 that partition the plurality of battery cells 110 horizontally and vertically. The first frame 333 and the second frame 335 are used not only to prevent deformation of the receiving body 311, but also to support and separate the plurality of battery cells 110.

According to an embodiment of the present disclosure, it is possible to prevent or delay high-temperature gas generated in a battery cell in which thermal runaway occurs among one or more battery cells provided inside the battery assembly from escaping in the tap direction of the battery cell.

According to another embodiment of the present disclosure, it is possible to vent according to the intended path the high-temperature gas generated in the battery cell in which the thermal runaway occurs.

According to another embodiment of the present disclosure, it is possible to provide a process of inserting the thermal delay assembly (or may be referred to as any one of a filler, a capsule member, and an insertion member) into an empty space formed between the busbar assembly and the cell tab of the battery may be added to the assembly process of the battery assembly.

According to another embodiment of the present disclosure, it is possible to facilitate the placement of the thermal delay assembly when assembling the battery assembly.

According to another embodiment of the present disclosure, it is possible to provide the stability of the battery assembly can be improved by increasing the heat resistance or fire resistance of the battery assembly.

Since the present disclosure may be implemented in various forms, the scope of rights is not limited to the above-described embodiments. Therefore, if the modified embodiment includes the elements of the claims of the present disclosure, it should be considered to fall within the scope of the present disclosure.

What is claimed is:

1. A battery assembly comprising:
a plurality of battery cells stacked and arranged in a stacking direction;
an accommodation case for accommodating the plurality of battery cells;
an insertion space formed between the plurality of battery cells and the accommodation case along the stacking direction; and
a thermal delay assembly located in the insertion space;
wherein the thermal delay assembly comprises
a fire-extinguishing member; and
a housing member for receiving the fire-extinguishing member therein.

2. The battery assembly according to claim 1, wherein the fire-extinguishing member starts to generate a fire-extinguishing gas at a predetermined first temperature,
the housing member begins to melt at a predetermined second temperature.

3. The battery assembly according to claim 2, wherein the first temperature is higher than or equal to the second temperature.

4. The battery assembly according to claim 2, wherein the fire-extinguishing member comprising:
one or more of a potassium compound, a phosphoric acid compound, or any combination thereof, which are pyrolyzed at the first temperature to generate the fire-extinguishing gas.

5. The battery assembly according to claim 1, wherein the housing member further comprises a fire-resistant member having a plurality of bead shapes including a fire-resistant material therein.

6. The battery assembly according to claim 5, wherein the fire-extinguishing member has a plurality of bead shapes.

7. The battery assembly according to claim 6, wherein the fire-resistant member and the fire-extinguishing member respectively are provided in a plurality, mixed with each other, and accommodated in the housing member.

8. The battery assembly according to claim 5, wherein the fire-resistant material includes silicon dioxide (SiO₂).

9. The battery assembly according to claim 1, wherein one end of at least one of both ends of the housing member is a tapered.

10. The battery assembly according to claim 1, wherein the housing member comprises:
a body portion having a pipe shape and extending along a height direction of the accommodation case;
a first end portion coupled to an upper side of the body portion and closing one of both open ends of the body portion; and
a second end portion coupled to a lower side of the body portion and closing the opened other end;
wherein the first end portion has a tapered shape in the direction away from the body portion.

11. The battery assembly according to claim 10, wherein the second end portion comprises an end face arranged in parallel with the bottom surface of the accommodation case.

12. The battery assembly according to claim 1, wherein the accommodation case comprises:
a receiving body including an opened upper surface, and receiving the plurality of battery cells through the opened upper surface; and
a receiving cover coupled to the receiving body, and covering the opened upper surface;
wherein one end of both ends of the housing member that is closer to the receiving cover than the receiving body is tapered.

13. The battery assembly according to claim 1, wherein a length of the housing member along a height direction of the accommodation case is longer than a length of the housing member along the stacking direction of the accommodation case.

14. The battery assembly according to claim 1, wherein a maximum length of the thermal delay assembly along the stacking direction is less than or equal to a thickness of any one of the plurality of battery cells.

15. The battery assembly according to claim 1, further include a busbar electrically connected to the plurality of battery cells,
wherein the insertion space is located between the busbar and the plurality of battery cells.

16. The battery assembly according to claim 15, wherein the insertion space is located outside the plurality of battery cells and is separated into a plurality of separation spaces formed by tab portions of the adjacent battery cells and the busbar,
the thermal delay assembly is provided in a plurality, and is inserted into at least a part of a plurality of separation spaces.

17. An assembling method comprising:
stacking a plurality of battery cells in a predetermined stacking direction;
coupling the plurality of stacked battery cells to a receiving cover;
inserting a thermal delay assembly into an insertion space, the thermal delay assembly comprising a fire-resistant member having a plurality of bead shapes, a fire-extinguishing member having a plurality of bead shapes, and a housing member, and the housing member that accommodates the fire-resistant member and the fire-extinguishing member; and
coupling a receiving body, which is coupled to the receiving cover and forms an accommodation case, to the receiving cover,
wherein the accommodation case houses the plurality of battery cells,
the insertion space forms between the plurality of battery cells and the accommodation case along the stacking direction,
the thermal delay assembly is located in the insertion space,
the fire-resistant member includes a fire-resistant material therein,
the fire-extinguishing member starts to generate a fire-extinguishing gas at a predetermined first temperature,
the housing member extends along a height direction of the accommodation case.

18. The assembling method according to claim 17, further comprises:
prior to the step of inserting the thermal delay assembly into the insertion space,
a first positioning step of positioning the plurality of stacked battery cells after being coupled to the receiving cover.

19. The assembling method according to claim 18, wherein the step of coupling the receiving body to the receiving cover comprises:
after the first positioning step, the plurality of stacked battery cells and the receiving cover couple with the receiving body.

20. The assembling method according to claim 18, further comprising:
after coupling the receiving body to the receiving cover,
a second positioning step of positioning the accommodation case.
